(19) United States
(12) Patent Application Publication
(10) Pub. No.: US 2014/0265248 A1
(43) Pub. Date: Sep. 18, 2014

(54) EXPANDABLE TRAILER

(71) Applicants: Chris Lee Ravencroft, Sparks, NV (US); Todd Francis Dechant, Wichita, KS (US); Chad Belding, Sparks, NV (US)

(72) Inventors: Chris Lee Ravencroft, Sparks, NV (US); Todd Francis Dechant, Wichita, KS (US); Chad Belding, Sparks, NV (US)

(21) Appl. No.: 13/829,500

(22) Filed: Mar. 14, 2013

(51) Int. Cl. B62D 63/06

(52) U.S. Cl. CPC B62D 63/061
USPC 280/491.1; 280/638

(57) ABSTRACT

An expandable trailer that is easy to store and transport yet is still large enough for most applications. The expandable trailer is shiftable between a relatively compact, retracted configuration for easy storage and/or transport and a relatively larger, expanded configuration for use in hauling items. Improved structures and mechanisms for selectively shifting the trailer between the retracted and expanded configurations are also disclosed.

### BACKGROUND

Trailers are frequently used for hauling a variety of items including hunting gear, building materials, plants, yard supplies, soil, gravel, etc. Many such trailers are designed for off-road use and are pulled by all terrain vehicles (ATVs), riding lawn mowers, tractors, truck, and the like. Trailers may be manufactured in a variety of sizes and shapes depending on their intended use.

Trailers are often stored in sheds, barns, or other structures while not in use. Some people even transport trailers and their towing vehicles from place to place on flat bed trucks or in larger enclosed trucks and trailers. Unfortunately, trailers take up a significant amount of space, thus forcing some owners to purchase smaller trailers than needed because of storage constraints. Similarly, trailers often must be pulled through narrow gates, doorways, or other openings and thus must be small enough to fit through such openings even though larger trailers would be more useful.

### SUMMARY

The present invention solves the above-described problems and provides a distinct advance in the art by providing an improved trailer that is easy to store and transport yet is still large enough to accommodate just about any desired use. Embodiments of the present invention achieve these objectives by providing an expandable trailer that is shiftable between a relatively compact, retracted configuration for easy storage and/or transport or for use in hauling smaller or fewer items and a relatively larger, expanded configuration for use in hauling larger items and/or a greater number of items. Embodiments of the invention also provide improved structures and mechanisms for selectively shifting the trailer between its retracted and expanded configurations.

An expandable trailer constructed in accordance with an embodiment of the invention broadly includes a chassis; a pair of wheel and tire assemblies for supporting the chassis for rolling movement above a ground surface; a pair of independent axles for rotatably attaching the wheel and tire assemblies to the chassis; and axle adjustment structure. The axle adjustment structure permits the axles and the wheel and tire assemblies to be selectively shifted between a retracted position in which the wheel and tire assemblies are spaced a relatively lesser distance apart and an expanded position in which the wheel and tire assemblies are spaced a relatively greater distance apart. When the axles are in their retracted position, the trailer may be more easily stored, transported, and pulled through gates, doorways, and other restricted openings. The trailer may also be used to haul smaller and/or fewer items when in its retracted position. When in the expanded position, the trailer may be used to haul larger and/or more items. Moreover, the distance between the tires is greatly expanded to improve the stability of the trailer when operated at higher speeds and/or on uneven ground. When expanded, the trailer may also be more easily pulled through water, ice, brush, crops, etc.

In one embodiment of the invention, the axle assemblies are L-shaped with a horizontally extending section that attaches to and extends out from the underside of the chassis and a vertically extending section that connects to its respective wheel and tire assembly. This configuration, along with the fact that the two axle assemblies are independent and unconnected to one another, provides much more clearance between the axles and the ground so that the trailer may be driven over rocks, stumps, and other debris that would normally interfere with a single straight axle.

Embodiments of the trailer may also include a tongue attached to the chassis for coupling the trailer with an all-terrain vehicle (ATV) or other towing vehicle and tongue adjustment structure. The tongue adjustment structure permits the tongue to be selectively shifted between a retracted, storage position in which the tongue extends a relatively lesser distance from the front of the chassis and an expanded, use position in which the tongue extends a relatively greater distance from the chassis.

Embodiments of the trailer may also include a plurality of central posts that may be coupled with the chassis for supporting an inner bag or flexible covering and removed from the chassis to convert the trailer to a flat-bed configuration.

Embodiments of the trailer may also include a plurality of side posts attached to the chassis for supporting removable side bags and side post adjustment structure for re-positioning the side posts. The side post adjustment structure permits the side posts to be selectively shifted between a retracted position in which the side posts are adjacent a side of the chassis and an expanded position in which the side posts are spaced further from the chassis.

The trailer may be used with or without the inner bag and side bags. The central posts and/or side posts may also be covered with a fabric or other covering to create sidewalls without the bags.

Embodiments of the trailer may further include a rear step attached to a rear end of the chassis to assist persons in stepping into and out of the trailer and step adjustment structure. The step adjustment structure permits the rear step to be selectively shifted between a lowered position in which the rear step is folded downwardly with respect to the chassis and a raised position in which the rear step is unfolded and extends generally horizontally from the rear of the chassis.

Embodiments of the trailer may also include a lift for permitting an operator to raise the chassis and wheel and tire assemblies off the ground so that the axles may be re-positioned and lift adjustment structure. The lift adjustment structure permits the lift to be selectively shifted between a retracted, storage position in which the lift is folded with respect to the chassis and an expanded, use position in which the lift is unfolded from the chassis.

The above-described trailer may be generally operated as follows. When in storage, being transported, or being used to haul smaller items, the trailer may be shifted to its relatively compact, retracted configuration in which the axle assemblies, tire and wheel assemblies, side posts, tongue, and rear step are all in their retracted or folded positions so that the trailer may be towed from its shed, enclosed larger trailer, or other enclosure and through any doorways, gates, and other restrictions. When it is desired to use the trailer for hauling larger items or greater quantities of items, the tongue may be shifted to its expanded position. Once the trailer is in the open, its lift structure is deployed to raise the tires from the ground. Once the tires are off the ground, the axle assemblies and tire and wheel assemblies may be shifted to their expanded positions and locked in place. The trailer may then be lowered and the lift may be pivoted to its raised and locked position. The rear step may then be raised to its use position. Then, the side posts may be extended to their extended positions to enlarge the storage space in the trailer. After use, the above-described steps are basically reversed, in any order, to place the trailer back into its retracted storage position.

This summary is provided to introduce a selection of concepts in a simplified form that are further described in the detailed description below. This summary is not intended to identify key features or essential features of the claimed subject matter, nor is it intended to be used to limit the scope of the claimed subject matter. Other aspects and advantages of the present invention will be apparent from the following detailed description of the embodiments and the accompanying drawing figures.

### BRIEF DESCRIPTION OF THE DRAWING FIGURES

Embodiments of the present invention are described in detail below with reference to the attached drawing figures, wherein:

FIG. 1 is a front perspective view of a trailer constructed in accordance with an embodiment of the invention and shown without any bags or coverings and with its axle assemblies and tongue in their retracted positions.

FIG. 2 is a front perspective view of the trailer shown with a central bag and two side bags and shown with its axle assemblies, side posts, and tongue in their retracted positions.

FIG. 3 is a front perspective view of the trailer shown with a central bag and two side bags and with its axle assemblies, side posts, and tongue in their expanded positions.

FIG. 4 is a front perspective view of the trailer shown with one set of its side rails in their retracted positions and the opposite set of side posts in their expanded position and a side bag shown removed from the expanded side posts.

FIG. 5 is a front perspective view of the trailer shown with one set of its side posts in their retracted positions and the opposite set of side rails in their expanded position an shown with a central bag and a side bag removed from trailer.

FIG. 6 is a front perspective view of the trailer shown with its floor removed.

FIG. 7 is a front perspective view of the trailer with its bags and bed floor removed and shown with its axle assemblies, side rails, and tongue in their expanded positions.

FIG. 8 is a front perspective view of the trailer with its bags and bed floor removed and shown with its axle assemblies, side rails, and tongue in their retracted positions.

FIG. 9 is a partial, bottom, perspective view of the trailer with the folding embodiment of the axle adjustment structure and shown with the axle assemblies and wheel and tire assemblies in their retracted positions.

FIG. 10 is a partial side perspective view of the trailer with the folding axle adjustment structure and shown with one of the axle assemblies and wheel and tire assemblies in their expanded positions.

FIG. 11 is a photograph taken from a side of the trailer showing the sliding embodiment of the axle adjustment structure with one axle assembly and wheel and tire assembly in their expanded positions.

FIG. 12 is a photograph taken from a side of the trailer showing the sliding embodiment of the axle adjustment structure with one axle assembly and wheel and tire assembly positioned in their retracted positions.

FIG. 13 is a side perspective view of the trailer shown with its tongue in its retracted position.

FIG. 14 is a partial side perspective view of the trailer shown with its tongue in its expanded position.

FIG. 15 is a rear side perspective view of the trailer shown with its rear step in its expanded position.

FIG. 16 is a photograph taken from a rear of the trailer showing the lift in its expanded use position.

FIG. 17 shows other embodiments of the invention.

FIG. 18 shows other embodiments of the invention.

FIG. 19 shows other embodiments of the invention.

FIG. 20 shows other embodiments of the invention.

FIG. 21 shows other embodiments of the invention.

FIG. 22 shows other embodiments of the invention.

FIG. 23 shows other embodiments of the invention.

FIG. 24 shows other embodiments of the invention.

The drawing figures do not limit the present invention to the specific embodiments disclosed and described herein. The drawings are not necessarily to scale, emphasis instead being placed upon clearly illustrating the principles of the invention.

### DETAILED DESCRIPTION

The following detailed description of embodiments of the invention references the accompanying drawings. The embodiments are intended to describe aspects of the invention in sufficient detail to enable those skilled in the art to practice the invention. Other embodiments can be utilized and changes can be made without departing from the scope of the claims. The following detailed description is, therefore, not to be taken in a limiting sense. The scope of the present invention is defined only by the appended claims, along with the full scope of equivalents to which such claims are entitled.

In this description, references to “one embodiment”, “an embodiment”, or “embodiments” mean that the feature or features being referred to are included in at least one embodiment of the technology. Separate references to “one embodiment”, “an embodiment”, or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, the present technology can include a variety of combinations and/or integrations of the embodiments described herein.

Turning now to the drawing figures, and initially FIG. 1, an expandable trailer 10 constructed in accordance with several embodiments of the invention is illustrated. The trailer 10 may be used for any application including hauling people, hunting gear, building materials, plants, yard supplies, soil, gravel, etc. and may be pulled by an all terrain vehicle (ATV), riding lawn mower, tractor, truck, or any other towing vehicle. As described below, embodiments of the trailer 10 are shiftable between a relatively compact, retracted configuration for easy storage, transport, and hauling of smaller items and a relatively larger, expanded configuration for use in hauling larger items and/or more items. The trailer may also be used for dumping purposes as described below.

An embodiment of the trailer 10 broadly includes a chassis 12; a pair of wheel and tire assemblies 14, 16 for supporting the chassis 12 for rolling movement above a ground surface; a pair of independent axle assemblies 18, 20 for rotatably attaching the wheel and tire assemblies to the chassis; and axle adjustment structure 22, 24 for each axle assembly. The axle adjustment structure 22, 24, embodiments of which are discussed in more detail below, permits the axles and the wheel and tire assemblies to be selectively shifted between a retracted position shown in FIGS. 1 and 2 in which the wheel and tire assemblies are spaced a relatively lesser distance apart and an expanded position shown in FIGS. 3 and 6 in which the wheel and tire assemblies are spaced a relatively greater distance apart.

The trailer 10 may also include a tongue 26 attached to the chassis for coupling the trailer with an all-terrain vehicle (ATV) or other towing vehicle and tongue adjustment structure 28. The tongue adjustment structure, an embodiment of which is described in detail below, permits the tongue to be selectively shifted between a retracted, storage position shown in FIG. 1 in which the tongue extends a relatively lesser distance from the chassis and an expanded, use position shown in FIG. 3 in which the tongue extends a relatively greater distance from the chassis.

The trailer 10 may also include a plurality of central posts 30 that may be removably coupled with the chassis 12 for supporting an inner bag 32 shown in FIG. 3. As described in more detail below, the central posts 30 may be removed from the chassis 12 to convert the trailer 10 to a flat-bed configuration.

The trailer 10 may also include a plurality of side posts 34 attached to the chassis 12 for supporting removable side bags 36 as shown in FIG. 3. The trailer also includes side post adjustment structure 38. The side post adjustment structure 38, embodiments of which are described in more detail below, permits the side posts 34 to be selectively shifted between a retracted position shown in FIGS. 1 and 8 in which the side posts are adjacent a side of the chassis and an expanded position shown in FIG. 7 in which the side posts are spaced further from the chassis.

As illustrated in FIG. 15, the trailer 12 may also include a rear step 40 attached to a rear end of the chassis 12 to assist persons in stepping into and out of the trailer and step adjustment structure 42. The step adjustment structure 42, an embodiment of which is described in detail below, permits the rear step to be selectively shifted between a lowered position in which the rear step is folded downwardly with respect to the chassis and a raised position shown in FIGS. 1 and 15 in which the rear step is unfolded and extends generally horizontally from the rear of the chassis.

The trailer may also include a lift 44 best illustrated in FIG. 16 for permitting an operator to raise the chassis 12 and wheel and tire assemblies 14, 16 off the ground so that the axles may be more easily shifted between their retracted and expanded positions. The trailer also includes lift adjustment structure 46, an embodiment of which is described in more detail below, that permits the lift 44 to be selectively shifted between a retracted, storage position in which the lift is folded with respect to the chassis and an expanded, use position in which the lift is unfolded from the chassis.

These and other aspects of the invention will now be described in more detail with reference to the noted drawing figures.

As best illustrated in FIG. 6, embodiments of the chassis 12 may include left and right side rails 48, 50 front and rear rails 52, 54 and a number of cross rails 56. All of the rails may be formed of hollow rectangular tubular steel. The chassis 12 also includes an axle assembly mount 58 that may have a greater size and/or thickness than the other rails.

The chassis 12 may also include a tongue-receiving socket 60 extending rearwardly from the front rail 52 and a pair of spaced apart supports 62, 64 extending rearwardly between the tongue-receiving socket 60 and the axle mount 58. The supports 62, 64 have a space between them for accommodating shifting of the tongue 26 as described below.

The trailer 10 may also include a bed or floor 66 formed from a rectangular piece of plywood or other material. The bed or floor may be one-piece or multiple pieces and may fold or slide out to increase the bed size when the trailer is expanded as described herein.

The wheel and tire assemblies 14, 16 support the chassis 12 for rolling movement above a ground surface. As best illustrated in FIG. 9, each includes a wheel hub 68, 70 a tire 72, 74 mounted to its wheel hub, and bearings or bushings 76, 78 mounted in the wheel hub for permitting rotation of the wheel and tire assemblies with respect to their axle assemblies. The size of the wheel and tire assemblies 14, 16 may vary depending on the use of the trailer.

The axle assemblies 18, 20 rotatably attach the wheel and tire assemblies to the chassis. As best illustrated in FIGS. 1 and 9, each includes a tubular axle shaft 80, 82 attached to one of the wheel hubs 68, 70 via one of the bearings or bushings 76, 78 and an L-shaped support tube 84, 86 having one end attached to one of the axle shafts 80, 82 and an opposite end for attachment to the chassis 12 as described below. The end of each support tube that attaches to the chassis has a vertically-extending pin-hole, the purpose of which is described below.

The L-shaped configuration of the axles, along with the fact that the two axle assemblies are independent and unconnected to one another, provides much more clearance between the axles and the ground so that the trailer may be driven over rocks, stumps, and other debris that would normally interfere with a single straight axle.

The axle adjustment structure 22, 24 permits the axle assemblies 18, 20 and the wheel and tire assemblies to be selectively shifted between a retracted position shown in FIGS. 1, 2, and 9 in which the wheel and tire assemblies are spaced a relatively lesser distance apart and an expanded position shown in FIGS. 3 and 10 in which the wheel and tire assemblies are spaced a relatively greater distance apart. When in their retracted configuration, the outside faces of the tires are spaced approximately 4′ apart and substantially flush with the side rails 48, 50 of the chassis. When in their expanded configuration, the outside faces of the tires may be spaced approximately 7′-3″ apart and are positioned outboard of the side rails of the chassis. One embodiment of the axle adjustment structure permits the axle assemblies to fold in and out between the retracted and expanded positions and another embodiment permits the axle assemblies to slide in and out between the retracted and expanded positions.

An embodiment of the folding axle adjustment structure is best shown in FIGS. 9 and 10 and includes, for each axle assembly, a vertically-extending hollow pivot tube 88, 90 attached to the chassis and a pivot pin 92, 94 that extends through the pivot tube and the pin hole in the end of its respective axle assembly support tube 84, 86 for pivotally coupling the axle assembly to the pivot tube. This permits each axle assembly 18, 20 to pivot about a vertical axis through the center of its pivot tube between its retracted, folded position and its expanded, unfolded position.

The folding embodiment of the axle adjustment structure also includes, for each axle assembly, a first holding bracket 92, 94 and a second holding bracket 96, 98. The holding brackets 92, 98 each include a pair of spaced apart, horizontally extending flanges 100, 102 interconnected by a vertically extending intermediate bight section 104. The horizontally extending flanges include vertically-aligned pin holes for receiving a locking pin 106. The first holding bracket is positioned one side of the pivot tube and is configured for holding its respective axle assembly in the retracted, folded position, and the second holding bracket is positioned on the opposite side of the pivot tube and configured for receiving and holding the axle assembly in the expanded, unfolded position.

The axle assembly for the wheel and tire assembly 16 may be shifted from its retracted position to its expanded position by unlocking it from its first holding bracket 92, pivoting it clockwise from the perspective of FIG. 9, and then locking it in place in its second holding bracket 96. The other axle assembly may be shifted to its expanded position in the same manner.

An embodiment of the sliding axle adjustment structure is best shown in FIGS. 11 and 12 and includes, for each axle assembly, a horizontally extending mounting tube 108 secured to the chassis and roller assemblies mounted above and below the opening in each mounting tube. The roller assemblies are essentially the same as the rolling assembly 128 shown in FIG. 14. Each mounting tube has a vertically-extending pin hole therein. The axle adjustment structure also includes a vertically extending locking pin mount 110 attached to the chassis directly above each of the mounting tubes and vertically aligned with the pin hole in the horizontally extending mounting tube. A locking pin 112 is shiftably received within the locking pin mount. In the sliding embodiment of the axle adjustment structure, a plurality of horizontally spaced-apart and vertically-extending pin holes are formed in the support tube of the respective axle assembly. The axle assembly may be slidably positioned in either its retracted or expanded positions by moving the axle assembly support tube within the mounting tube of the axle adjustment structure, aligning one of the pin holes in the support tube with the pin hole in the mounting tube, and inserting the locking pin in the aligned pin holes.

The folding axle adjustment structure described above is preferred when the trailer 10 is used in harsh conditions because, with the sliding axle adjustment structure, mud, snow, ice, dirt, sand, etc. can accumulate on the axles and roller assemblies and prevent the axles from freely sliding in and out of their respective mounting tubes. The folding axle adjustment structure doesn't suffer from this problem because it pivots and folds rather than sliding them in and out of open mounting tubes.

The tongue 26 is attached to the chassis 12 for coupling the trailer with an all-terrain vehicle (ATV) or other towing vehicle. As best illustrated in FIGS. 1, 13, and 14, an embodiment of the tongue 26 includes a forward section 114 that may attach to a ball mount socket, pinnel hitch, or any other hitch, a rear section 116 that is received within the socket 60, and an angled intermediate section 118. The rear section includes at two or more sets of mounting holes along its length, the purpose of which is described below.

The tongue adjustment structure 28 permits the tongue to be selectively shifted between a retracted, storage position shown in FIG. 13 in which the tongue extends a relatively lesser distance from the chassis and an expanded, use position shown in FIG. 14 in which the tongue extends a relatively greater distance from the chassis. An embodiment of the tongue adjustment structure 28 is best shown in FIG. 14 and includes the tongue-receiving socket 60 described above and a locking bracket 120 attached to the forward most open end of the socket. The locking bracket 120 includes a pair of vertically-extending flanges 122, 124 mounted on opposite sides of the socket. The flanges include horizontally-aligned pin holes for receiving a locking pin 126. A rolling pin 128 may also be also supported between the flanges adjacent the top of the socket for easing the movement of the tongue in and out of the socket. The tongue may be slidably positioned in either its retracted or expanded positions by moving the tongue in or out of the socket and aligning one of the pin holes in the rear section of the tongue with the pin holes in the locking bracket and inserting the locking pin in the aligned pin holes.

The central posts 30 are provided for supporting the inner bag 32 and for supporting the inner sides of the side bags as best illustrated in FIGS. 2-5 and FIG. 10. The central posts may be formed of rectangular, tubular steel and are removably received in vertically extending open ended sockets 130 attached to the chassis. The inner bag may be formed of 600 by 300 PVC backed denier polyester, 18 ounce vinyl coated polyester, or any other durable and flexible material. The bag includes a number of rectangular-shaped pockets that fit over the upper ends of the central posts for supporting the bag on the trailer.

The side posts 34 are attached to the chassis for supporting the outside faces of the side bags 36 as best illustrated in FIGS. 2-5. The side posts may be formed of rectangular, tubular steel and each is generally L-shaped with a horizontally-extending section and a vertically-extending section. The vertically-extended section may be T-shaped or include other supports to more effectively support the bags and/or flexible materials wrapped around the side posts.

The side posts are supported by side post adjustment structure that permits the side posts to be selectively shifted between a retracted position in which each of the side posts are adjacent one of the central posts as show in FIGS. 1, 2, and 8 and an expanded position in which the side posts are extended from the central posts as shows in FIGS. 3 and 7. The side post adjustment structure essentially serve as trailer bed extenders that permit a user to selectively increase the width of the trailer for additional carrying capacity. When the side bags are attached to the trailer, shifting the side posts expands the bags. When the side bags are removed, expanding the side posts increases the bed space on the trailer.

One embodiment of the side post adjustment structure is best illustrated in FIG. 10 and includes, for each side post, a horizontally extending mounting tube 132 secured to the chassis for receiving the horizontally-extending section of its side post. The mounting tubes and the horizontally-extending sections of the side posts may include vertically-extending pin holes for receiving locking pins. The side posts may be slidably positioned in either their retracted or expanded positions by moving their horizontal sections in or out of the mounting and inserting the locking pins in the aligned pin holes.

Another embodiment of the side post adjustment structure is best illustrated in FIG. 11 and includes, for each side post, a vertically-extending socket 134 attached to the chassis and configured for receiving a cylindrical mounting post depending from its respective side post. The side posts may pivot with respect to the socket and be either swung outwardly to their expanded positions or folded against the chassis to their retracted, folded positions.

The side bags 36 may be formed of 600 by 300 PVC backed denier polyester, 18 ounce vinyl coated polyester, or any other durable and flexible material. The bags include a number of rectangular-shaped pockets that fit over the upper ends of the central posts for supporting the bags on the trailer and a number of snaps, hooks, or other fasteners for attaching to the center bag. When the outer bags are placed over the side posts, the bags fold and retract along with the side posts. The L-shaped side posts support the undersides and outer sides of the side bags to prevent or at least reduce tearing of the side bags.

The central posts, side posts, center bag, and side bags may also be removed from the chassis to convert the trailer to a flat-bed configuration. In some embodiments, the side posts are expanded but the central posts are removed to create a single large enclosed space. In other embodiments, the bags may be removed and replaced with flexible material attached to the central posts and/or the side posts to create flexible side walls on the trailer.

The rear step 40 is attached to a rear end of the chassis as best illustrated in FIG. 15 to assist persons in stepping into and out of the trailer. The step adjustment structure 42 permits the rear step to be selectively shifted between a lowered position in which the rear step is folded with respect to the chassis and a raised position shown in FIG. 15 in which the rear step is unfolded and extends generally horizontally from the rear of the chassis. An embodiment of the step adjustment structure includes a pair of support brackets 136, 138 attached to opposite sides of the rear of the chassis and corresponding mounting brackets 140, 142 attached to opposite sides of the rear step. The support brackets and mounting brackets have horizontally-extending mounting holes that are aligned when the rear step is raised and that receive a locking pin 144, 146 to lock the step in its raised position.

The lift 44 permits a single operator, without assistance from others, to raise the chassis 12 and wheel and tire assemblies 14, 16 off the ground to more easily shift the axles between their retracted and expanded positions. An embodiment of the lift is formed from rectangular tubular steel and includes an elongated leg 148 and a horizontally-extending foot 150 attached perpendicularly to the bottom of the leg. The foot may include a number of ground piercing spikes 152 that firmly plant the foot in the ground when the lift is engaged as described below.

The lift adjustment structure 46 permits the lift to be selectively shifted between a raised, storage position in which the lift is folded against the underside of the chassis and a lowered, use position shown in FIG. 16 in which the lift is unfolded and extends substantially vertically below the chassis. An embodiment of the lift adjustment structure includes a vertically-extending support flange 154 extending from the chassis and a pivot pin 156 extending through the support flange and upper end of lift leg for pivotally attaching the lift to the underside of the chassis. The lift adjustment structure also includes a locking pin that may be inserted in a set of aligned holes in the support flange and the lift to lock the lift in its raised and locked position.

The above-described trailer 10 may be used as follows. When in storage, being transported, or being used to haul smaller and/or a lesser number of items, the trailer 10 may be in its relatively compact, retracted configuration in which the axle assemblies, tire and wheel assemblies, side posts, tongue, and rear step are all shifted to their retracted or folded positions. In this state, one embodiment of the trailer may be approximately 4′-3″ wide and 9′-9.5″ long, its tongue extends 1′-9.5″ from the front of chassis, its wheels are spaced approximately 4′-3″ apart, and its rear step is folded down. When it is desired to use the trailer for hauling larger items and/or more items, the tongue may be shifted to its expanded position and the ball socket or other hitch component on the tongue placed over a ball hitch or other hitch on a towing vehicle. The lift may then be lowered to its use position until its foot touches the ground. The trailer may then be pulled forwardly until the stakes on the foot of the lift dig in the ground and the lift acts as fulcrum to lift the wheels off the ground.

Once the tires are off the ground, the axle assemblies and tire and wheel assemblies may be shifted to their expanded positions and locked in place. The towing vehicle may then be driven slowly in reverse until the lift pivots toward its folded position and lowers the tires to the ground. Once the tires are supporting the weight of the trailer, the lift may be pivoted to its fully raised position and locked in place.

The rear step may then be raised to its use position. Then, the side posts may be extended to their extended positions to enlarge the hauling capacity of the trailer for hauling larger items or more items. In this state, one embodiment of the trailer may be approximately 8′-5″ wide and 12′-10″ long, its tongue extends 3′-10″ from the front of chassis, its wheels are spaced 7′-3″ apart, and its rear step is up.

With it's expanding and retracting feature, the trailer can adjust to fit and haul most oversized disposable waste collection bags that are purchased at specific retailers—these bags are for smaller to medium projects that don't require a full sized dumpster. Waste management companies have trouble picking up these specific bags because many times they're filled too heavy to move and too far away to pick up. After the bag was filled on the expanding or retracting trailer or cart of renovation debris, landscaping, or home projects etc, the trailer/cart would haul and leave the filled disposable bag close enough to the street for the waste collection company to pickup the bag and haul it away for proper disposal.

If the trailer is pulled back into its enclosure or transport trailer after use, the above-described steps are basically reversed, in any order, to place the trailer back into its retracted storage position.

Embodiments of the trailer may also be configured for rear or side dumping of items in the trailer. During side dumping, extension of the opposite axle and wheel and tire assembly helps stabilize the trailer. During rear dumping, extension of both axle assemblies helps stabilize the trailer. When used for dumping items from the trailer, the rear step may be folded down.

FIGS. 17-24 show additional aspects of the invention.

Although the invention has been described with reference to the preferred embodiment illustrated in the attached drawing figures, it is noted that equivalents may be employed and substitutions made herein without departing from the scope of the invention as recited in the claims.

Having thus described the preferred embodiment of the invention, what is claimed as new and desired to be protected by Letters Patent includes the following:

1. An expandable trailer comprising:
a chassis;
a pair of wheel and tire assemblies for supporting the chassis for rolling movement above a ground surface;
a pair of independent axles for rotatably attaching the wheel and tire assemblies to the chassis; and
axle adjustment structure for permitting the axles and the wheel and tire assemblies to be selectively shifted between a retracted position in which the wheel and tire assemblies are spaced a relatively lesser distance apart and an expanded position in which the wheel and tire assemblies are spaced a relatively greater distance apart.

2. The expandable trailer as set forth in claim 1, further comprising a tongue attached to the chassis for coupling the trailer with an all-terrain vehicle (ATV), riding lawn mower, or other towing vehicle and tongue adjustment structure for permitting the tongue to be selectively shifted between a retracted, storage position in which the tongue extends a relatively lesser distance from the chassis and an expanded, use position in which the tongue extends a relatively greater distance from the chassis.

3. The expandable trailer as set forth in claim 1, further comprising a plurality of central posts that may be coupled with the chassis for supporting an inner bag and removed from the chassis to convert the trailer to a flat-bed configuration.

4. The expandable trailer as set forth in claim 1, further comprising a plurality of side rails attached to the chassis for supporting removable sides and side rail adjustment structure for permitting the side rails to be selectively shifted between a retracted position in which the side rails are adjacent a side of the chassis and an expanded position in which the side rails are spaced further from the chassis.

5. The expandable trailer as set forth in claim 1, further comprising a rear step attached to a rear end of the chassis to assist persons in stepping into and out of the trailer and step adjustment structure for permitting the rear step to be selectively shifted between a retracted position in which the rear step is folded with respect to the chassis and an expanded position in which the rear step is unfolded from the chassis.

6. The expandable trailer as set forth in claim 1, further comprising a lift structure for permitting an operator to raise the chassis and wheel and tire assemblies off the ground surface during the shifting of the axles between the retracted and expanded positions and lift adjustment structure for permitting the lift to be selectively shifted between a retracted, storage position in which the lift is folded with respect to the chassis and an expanded, use position in which the lift is unfolded from the chassis.

7. An expandable trailer comprising:
a chassis;
a pair of wheel and tire assemblies for supporting the chassis for rolling movement above a ground surface;
a pair of independent axles for rotatably attaching the wheel and tire assemblies to the chassis;
axle adjustment structure for permitting the axles and the wheel and tire assemblies to be selectively shifted between a retracted position in which the wheel and tire assemblies are spaced a relatively lesser distance apart and an expanded position in which the wheel and tire assemblies are spaced a relatively greater distance apart;
a tongue attached to the chassis for coupling the trailer with an all-terrain vehicle (ATV) or other towing vehicle;
tongue adjustment structure for permitting the tongue to be selectively shifted between a retracted, storage position in which the tongue extends a relatively lesser distance from the chassis and an expanded, use position in which the tongue extends a relatively greater distance from the chassis;
a plurality of central posts that may be coupled with the chassis for supporting an inner bag and removed from the chassis to convert the trailer to a flat-bed configuration;
a plurality of side rails attached to the chassis for supporting removable sides;
side rail adjustment structure for permitting the side rails to be selectively shifted between a retracted position in which the side rails are adjacent a side of the chassis and an expanded position in which the side rails are spaced further from the chassis;
a rear step attached to a rear end of the chassis to assist persons in stepping into and out of the trailer;
step adjustment structure for permitting the rear step to be selectively shifted between a retracted position in which the rear step is folded with respect to the chassis and an expanded position in which the rear step is unfolded from the chassis;
a lift structure for permitting an operator to raise the chassis and wheel and tire assemblies off the ground surface during the shifting of the axles between the retracted and expanded positions; and
lift adjustment structure for permitting the lift to be selectively shifted between a retracted, storage position in which the lift is folded with respect to the chassis and an expanded, use position in which the lift is unfolded from the chassis.

8. An expandable trailer comprising:
a chassis;
a pair of wheel and tire assemblies for supporting the chassis for rolling movement above a ground surface;
a pair of independent axle assemblies for rotatably attaching the wheel and tire assemblies to the chassis; and
axle adjustment structure for permitting the axle assemblies and the wheel and tire assemblies to be selectively pivoted between a retracted, folded position in which the wheel and tire assemblies are folded in relative to the chassis and spaced a relatively lesser distance apart and an expanded, unfolded position in which the wheel and tire assemblies are unfolded relative to the chassis and spaced a relatively greater distance apart.

9. The expandable trailer as set forth in claim 8, wherein each of the wheel and tire assemblies includes a wheel hub, a tire mounted to the wheel hub, and bearings or bushings mounted in the wheel hub; and wherein each of the independent axle assemblies includes a tubular axle shaft attached to one of the wheel hubs via one of the bearings or bushings, and a support tube having one end attached to one of the axle shafts and an opposite end having a vertically-extending pin-hole.

10. The expandable trailer as set forth in claim 9, wherein the axle adjustment structure includes, for each axle assembly, a vertically-extending hollow pivot tube attached to the chassis, a pivot pin extending through the pivot tube and the pin hole in its respective support tube for pivotally coupling the support tube to the pivot tube and permitting the support tube to pivot about the pivot tube to position its axle assembly between the retracted, folded position and the expanded, unfolded position.

11. The expandable trailer as set forth in claim 10, wherein the axle adjustment structure further includes, for each axle assembly, a pair of first and second holding brackets, wherein the first holding bracket is configured and positioned to receive and hold its respective axle assembly in the retracted, folded position and wherein the second holding bracket is configured and positioned to receive and hold its respective axle assembly in the expanded, unfolded position

12. The expandable trailer as set forth in claim 8, further comprising a tongue attached to the chassis for coupling the trailer with an all-terrain vehicle (ATV) or other towing vehicle and tongue adjustment structure for permitting the tongue to be selectively shifted between a retracted, storage position in which the tongue extends a relatively lesser distance from the chassis and an expanded, use position in which the tongue extends a relatively greater distance from the chassis.

13. The expandable trailer as set forth in claim 8, further comprising a plurality of central posts that may be coupled with the chassis for supporting an inner bag and removed from the chassis to convert the trailer to a flat-bed configuration.

14. The expandable trailer as set forth in claim 8, further comprising a plurality of side rails attached to the chassis for supporting removable sides and side rail adjustment structure for permitting the side rails to be selectively shifted between a retracted position in which the side rails are adjacent a side of the chassis and an expanded position in which the side rails are spaced further from the chassis.

15. The expandable trailer as set forth in claim 8, further comprising a rear step attached to a rear end of the chassis to assist persons in stepping into and out of the trailer and step adjustment structure for permitting the rear step to be selectively shifted between a retracted position in which the rear step is folded with respect to the chassis and an expanded position in which the rear step is unfolded from the chassis.

16. The expandable trailer as set forth in claim 8, further comprising a lift structure for permitting an operator to raise the chassis and wheel and tire assemblies off the ground surface during the shifting of the axles between the retracted and expanded positions and lift adjustment structure for permitting the lift to be selectively shifted between a retracted, storage position in which the lift is folded with respect to the chassis and an expanded, use position in which the lift is unfolded from the chassis.

17. An expandable trailer comprising:
a chassis;
a pair of wheel and tire assemblies for supporting the chassis for rolling movement above a ground surface;
a pair of independent axle assemblies for rotatably attaching the wheel and tire assemblies to the chassis; and
axle adjustment structure for permitting the axle assemblies and the wheel and tire assemblies to be slidably positioned between a retracted position in which the wheel and tire assemblies are slid-in relative to the chassis and spaced a relatively lesser distance apart and an expanded position in which the wheel and tire assemblies are slid-out relative to the chassis and spaced a relatively greater distance apart.

18. The expandable trailer as set forth in claim 17, wherein each of the wheel and tire assemblies includes a wheel hub, a tire mounted to the wheel hub, and bearings or bushings mounted in the wheel hub; and wherein each of the independent axle assemblies includes a tubular axle shaft attached to one of the wheel hubs via one of the bearings or bushings, and a support tube having one end attached to one of the axle shafts and an opposite end configured for attachment to the axle adjustment structure.

19. The expandable trailer as set forth in claim 18, wherein the axle adjustment structure includes, for each axle assembly, a hollow, horizontally extending mounting tube secured to the chassis and a having a vertically-extending pin hole therein; a hollow, vertically extending locking pin mount attached to the chassis and vertically aligned with the pin hole in the horizontally extending mounting tube; a locking pin shiftably received within the locking pin mount; and a plurality of horizontally spaced apart vertically-extending pin holes formed in the support tube of the respective axle assembly, whereby the axle assembly may be slidably positioned in either its retracted or expanded positions by moving the axle assembly support tube within the mounting tube of the axle adjustment stricter and aligning one of the pin holes in the support tube with the pin hole in the mounting tube and inserting the locking pin in the aligned pin holes.

20. The expandable trailer as set forth in claim 17, further comprising:
a tongue attached to the chassis for coupling the trailer with an all-terrain vehicle (ATV) or other towing vehicle;
tongue adjustment structure for permitting the tongue to be selectively shifted between a retracted, storage position in which the tongue extends a relatively lesser distance from the chassis and an expanded, use position in which the tongue extends a relatively greater distance from the chassis;
a plurality of central posts that may be coupled with the chassis for supporting an inner bag and removed from the chassis to convert the trailer to a flat-bed configuration;
a plurality of side rails attached to the chassis for supporting removable sides;
side rail adjustment structure for permitting the side rails to be selectively shifted between a retracted position in which the side rails are adjacent a side of the chassis and an expanded position in which the side rails are spaced further from the chassis;
a rear step attached to a rear end of the chassis to assist persons in stepping into and out of the trailer;
step adjustment structure for permitting the rear step to be selectively shifted between a retracted position in which the rear step is folded with respect to the chassis and an expanded position in which the rear step is unfolded from the chassis;
lift structure for permitting an operator to raise the chassis and wheel and tire assemblies off the ground surface during the shifting of the axles between the retracted and expanded positions; and
lift adjustment structure for permitting the lift to be selectively shifted between a retracted, storage position in which the lift is folded with respect to the chassis and an expanded, use position in which the lift is unfolded from the chassis.
